(19) United States
(12) Patent Application Publication
(10) Pub. No.: US 2022/0040885 A1
(43) Pub. Date: Feb. 10, 2022

(54) METHOD FOR IMPREGNATING POLYMER GRANULATES

(71) Applicant: Linde GmbH, Pullach (DE)

(72) Inventors: Rolf HENINGER, Höhenkirchen-Siegertsbrunn (DE); Andreas PRALLER, Germering (DE); Pawel SZYCH, München (DE)

(21) Appl. No.: 17/280,259

(22) PCT Filed: Oct. 10, 2019
(86) PCT No.: PCT/EP2019/025339

§ 371 Date: Mar. 26, 2021

(30) Foreign Application Priority Data
Oct. 15, 2018 (EP) 18020498.4
Oct. 31, 2018 (DE) 10 2018 008 534.2

(51) Int. Cl. B29B 9/16

(52) U.S. Cl. CPC B29B 9/16; B29K 2023/12; B29B 2009/161

(57) ABSTRACT

The invention relates to a method for impregnating a polymer granulate with a predefined mass of a gaseous propellant. According to the invention, the polymer granulate is arranged inside a pressure vessel and a gaseous propellant is introduced into the inside of the pressure vessel.

The invention relates to a method for impregnating a polymer granulate.

A polymer granulate is impregnated with a propellant before the polymer granulate treated in this way is used for the production of a component, for example by injection molding.

The term “impregnate” means that the propellant is absorbed by the polymer granulate. The propellant is at least partially absorbed by or bonded to the polymer granulate. This can also be referred to as loading the polymer granulate with the propellant. How much propellant has been absorbed by the polymer granulate in relation to the polymer granulate is also referred to as the “degree of loading”.

According to the prior art, methods for impregnating a polymer granulate are known in which a polymer granulate is impregnated with the propellant at a predefined pressure and a predefined temperature for a predetermined time. The predetermined time, the predefined pressure and the predefined temperature are based, for example, on previously performed series of tests.

Some prior art methods have an additional preparation step (“conditioning”), in which the polymer granulate is pretreated and, for example, temperature-adjusted to a certain temperature in the process, before the impregnation. This requires an additional device for performing the preparation step. In addition, the time required is increased in comparison with a method in which no preparation step is carried out.

A certain degree of loading is intended for a large number of uses of an impregnated polymer granulate.

In the methods known from the prior art, it is not known during the process of impregnation how much propellant has been absorbed by the polymer granulate, i.e. the degree of loading is not known during the method. Complex series of tests are necessary to determine the corresponding conditions for a certain degree of loading. Nevertheless, after the predetermined time of impregnation, the polymer granulate may have a degree of loading that is lower or higher than the desired degree of loading. This can be due, for example, to the fact that the series of tests are not sufficiently detailed or that the polymer granulate has a different initial condition, for example a different temperature, than in the series of tests. To counteract the latter, the polymer granulate may be subjected to at least one pretreatment step prior to impregnation.

A method in which the degree of loading can be determined during impregnation is of interest.

This object is achieved by a method for impregnating a polymer granulate with a predefined mass of a gaseous propellant according to claim 1 or a method for impregnating a polymer granulate with a predefined mass of a gaseous propellant according to claim 5. Advantageous embodiments of the method are specified in the corresponding dependent claims.

A first aspect of the invention relates to a method for impregnating a polymer granulate with a predefined mass of a gaseous propellant. The polymer granulate is arranged inside a pressure vessel and a gaseous propellant is initially introduced into the inside of the pressure vessel. The propellant is absorbed by the polymer granulate and a current pressure p₂ prevailing in the inside is determined. A current mass Δm of the propellant absorbed by the polymer granulate is determined as the difference between the mass m₁ of the total propellant initially introduced into the inside of the pressure vessel and the mass m₂ of a non-absorbed part of the propellant currently located in the inside. The method is terminated when the current mass of the absorbed propellant is greater than or equal to the predefined mass.

The pressure vessel may be an autoclave.

The current pressure can be determined, in particular measured, by means of at least one pressure sensor in the inside of the pressure vessel. The at least one pressure sensor may record pressure data. In one embodiment of the method according to the invention, the at least one pressure sensor can make the recorded pressure data available for further use.

Furthermore, the current pressure can be measured repeatedly during absorption of the propellant. In one embodiment of the method, the current pressure can be determined continuously.

The initially introduced mass and the current pressure can be used to calculate the non-absorbed mass of the propellant. The difference between the initially introduced mass and the non-absorbed mass gives the current mass of the propellant absorbed by the polymer granulate. That is, the current mass of the propellant absorbed by the polymer granulate can be calculated using physical variables that are easily measurable.

An advantage of this method according to the invention is that the current mass of the absorbed propellant can be determined, in particular can be determined during the process of impregnation. Once the current mass of the absorbed propellant is greater than or equal to the predefined mass, the impregnation may be discontinued, i.e., terminated. In other words, the degree of loading can be determined during the impregnation, and the impregnation can be terminated as soon as a predefined degree of loading is reached. In one embodiment of the method, the method is automatically terminated when the current mass of the absorbed propellant is greater than or equal to the predefined mass.

Furthermore, neither a pretreatment of the polymer granulate nor previously performed series of tests are necessary, and therefore advantages in terms of both time and cost can be achieved by the method.

According to one embodiment of the method, a current temperature T₂ in the inside of the pressure vessel is measured.

The current temperature is the temperature currently prevailing in the inside of the pressure vessel.

The current temperature T₂ can be measured by means of at least one temperature sensor in the inside of the pressure vessel. In one embodiment, the current temperature may be measured repeatedly. In one embodiment, the current temperature may be measured continuously.

The at least one temperature sensor may be configured to record temperature data. According to one embodiment, the at least one temperature sensor can make the recorded temperature data available for further use.

A measurement of the temperature can be dispensed with if its influence on the determination of the amount of propellant absorbed can be regarded as negligible or the temperature in the pressure vessel can be regarded as constant, for example thanks to sufficient thermal insulation.

In other words, in order to determine the absorbed quantity of the propellant, the current temperature in the inside of the pressure vessel must be measured, at least in the case of a pressure vessel that is not sufficiently insulated, in order to take into account the influence of the temperature.

According to one embodiment of the method, the current mass is determined by means of a programmable logic controller.

In one embodiment, the programmable logic controller is configured such that it can calculate the current mass using the pressure data or the pressure data and the temperature data.

According to one embodiment, the programmable logic controller may calculate the current mass continuously using the current pressure or the current pressure and the current temperature.

When the calculated current mass of the absorbed propellant is greater than or equal to a predefined mass, the process of impregnation is discontinued or terminated.

An advantage of this embodiment is that the current mass of the absorbed propellant is automatically calculated continuously, so that the degree of loading can be determined at any time. The process of impregnation can be terminated immediately when the predefined degree of loading is reached, i.e. when the calculated current mass of the absorbed propellant is greater than or equal to a predefined mass.

According to one embodiment, the method is characterized in that the mass of the non-absorbed part of the propellant (m) currently located in the inside is determined by means of the relationship:

$${m}_{1} = \frac{{p}_{1} \cdot V}{{R}_{S} \cdot {T}_{1}} .$$

In this case, p₁ and T₁ are an initial pressure prevailing in the inside before absorption of the propellant and an initial temperature prevailing in the inside before absorption of the propellant. The mass m₁ denotes the mass of the total propellant initially introduced into the inside of the pressure vessel.

V is a volume of the propellant in the pressure vessel, which can be determined from the difference between a volume of the inside of the pressure vessel and a volume of the polymer granulate arranged in the inside. The volume of the polymer granulate arranged in the inside is a volume occupied by the polymer granulate in the inside of the pressure vessel.
R_{S} denotes the specific gas constant of the gas or gas mixture, which can consist, for example, of the propellant and air, present in the empty volume. For the sake of simplicity, it can be assumed that the specific gas constant of the propellant is used for R_{S}.

The amount of propellant absorbed in the polymer granulate can be calculated by determining the pressure p₂ currently prevailing in the pressure vessel and the temperature T₂ by means of the relationship:

$$Δ m = \frac{V}{{R}_{S}} ( \frac{{p}_{1}}{{T}_{1}} - \frac{{p}_{2}}{{T}_{2}} )$$

In this case, T₁ and T₂ can represent the mean value from different temperature measurement points in the pressure vessel.

The initial temperature T₁ is in particular in a range between 0° C. and 180° C., in particular between 10° C. and 120° C. The initial pressure p₁ is in particular between 80 bar and 5 bar, in particular between 45 bar and 30 bar.

In an alternative embodiment, the mass of the propellant initially introduced into the inside of the pressure vessel is determined when the propellant is introduced.

The mass of the non-absorbed part of the propellant currently in the inside can therefore advantageously be determined using easily determinable physical variables.

A further aspect of the invention relates to a method for impregnating a polymer granulate with a predefined mass of a gaseous propellant, the polymer granulate being arranged in an inside of a pressure vessel. A gaseous propellant is initially introduced into the inside of the pressure vessel, so that propellant is absorbed by the polymer granulate. Propellant is subsequently added to the inside of the pressure vessel, wherein the masses of the initially m₁ and subsequently introduced propellant Δmₐ are determined. A current mass Δm of the propellant absorbed by the polymer granulate is determined using the masses of the propellant initially and subsequently introduced into the inside. The method is terminated when the current mass of the absorbed propellant is greater than or equal to the predefined mass.

The pressure vessel is an autoclave, for example.

The current pressure can be determined by means of at least one pressure sensor in the inside of the pressure vessel. The at least one pressure sensor may record pressure data. In one embodiment of the method according to the invention, the recorded pressure data can be made available for further use.

The current pressure can be measured repeatedly during absorption of the propellant. In one embodiment of the method, the current pressure can be determined continuously.

The current mass of the absorbed propellant may be determined during the process of impregnation. Once the current mass of the absorbed propellant is greater than or equal to the predefined mass, the impregnation may be discontinued. In other words, the degree of loading can be determined during the impregnation. The impregnation can be discontinued as soon as a predefined degree of loading is reached, i.e. the process of impregnation can be terminated immediately when the predefined degree of loading is reached.

In one embodiment of the method, the method is automatically discontinued when the current mass of the absorbed propellant is greater than or equal to the predefined mass.

According to one embodiment of the method, a current temperature T₂ in the inside of the pressure vessel is measured.

In this case, the current temperature is the temperature currently prevailing in the inside of the pressure vessel.

The current temperature T₂ can be measured by means of at least one temperature sensor in the inside of the pressure vessel. In one embodiment, the current temperature may be determined repeatedly. In one embodiment, the current temperature may be measured continuously.

The at least one temperature sensor may be configured to record temperature data. According to one embodiment of the method, the at least one temperature sensor can make the recorded temperature data available for further use.

According to one embodiment, the method is characterized in that the current pressure p₂ prevailing in the inside is measured, and the respectively subsequently introduced propellant is introduced continuously into the inside, so that the pressure prevailing in the inside remains constant.

In other words, this means that propellant is subsequently introduced continuously into the pressure vessel, so that the pressure prevailing in the inside of the pressure vessel remains constant.

Before absorption of the propellant, an initial pressure (p₁) prevails in the inside of the pressure vessel. In one embodiment of the method, propellant is introduced subsequently in such a way that the currently prevailing pressure is equal to the initial pressure.

The propellant can be introduced subsequently into the inside of the pressure vessel by means of a pressure regulator.

This embodiment of the method is advantageous in that the pressure prevailing in the inside remains constant and thus the conditions of the impregnation remain stable.

In an alternative embodiment, the current pressure p₂ prevailing in the inside is measured, and the respectively subsequently introduced propellant is introduced into the inside at regular intervals, so that the pressure prevailing in the inside after the respective interval is constant.

In one embodiment, the pressure prevailing in the inside after the respective interval is equal to the initial pressure.

According to one embodiment, propellant is subsequently introduced into the inside of the pressure vessel if the difference between the pressure prevailing in the inside after the respective interval and the currently prevailing pressure p₂ has an absolute value of in particular more than 1 bar, in particular more than 0.5 bar, in particular more than 0.1 bar.

According to a further embodiment of the method, the current mass (Δm) of the propellant absorbed by the polymer granulate is determined by means of the relationship

$$Δ m = Δ {m}_{a} + \frac{V}{{R}_{S}} ( \frac{{p}_{1}}{{T}_{1}} - \frac{{p}_{2}}{{T}_{2}} ) .$$

In this case, Δmₐ is the mass of the propellant subsequently introduced into the pressure vessel. T₁ is an initial temperature prevailing in the inside before absorption of the propellant, and T₂ is the current temperature in the inside of the pressure vessel. p₁ is the pressure prevailing before absorption, and p₂ is the currently prevailing pressure in the pressure vessel.

If it can be assumed that the temperature and the pressure in the pressure vessel during the impregnation remains approximately unchanged (i.e. T₁=T₂ and p₁=p₂), the absorbed amount of propellant corresponds to the amount of subsequently introduced propellant, i.e. Δm=Δmₐ.

In one embodiment, the mass of the propellant subsequently introduced into the pressure vessel may be measured using a mass flow meter. In an alternative embodiment, the mass of the propellant introduced subsequently into the pressure vessel can be determined from a change in a total mass of the pressure vessel with the polymer granulate located in the inside and the propellant.

This means that the current mass can be determined using easily determinable measurement variables, such as the masses of the propellant initially and subsequently introduced into the pressure vessel.

An embodiment of the method is characterized in that the current pressure prevailing in the inside is measured. Furthermore, the current mass Δm of the propellant absorbed by the polymer granulate is determined using the masses of the propellant initially and subsequently introduced into the inside and the current pressure p₂. The method is discontinued when the current mass Δm of the absorbed propellant is greater than or equal to the predefined mass.

In one embodiment, the current mass may be determined repeatedly. In an alternative embodiment, the current mass may be determined continuously.

According to one embodiment of the method, a current temperature T₂ in the inside of the pressure vessel is measured.

In this case, the current temperature is the temperature currently prevailing in the inside of the pressure vessel.

The current temperature T₂ can be measured by means of at least one temperature sensor in the inside of the pressure vessel. In one embodiment, the current temperature may be determined repeatedly. In one embodiment, the current temperature may be measured continuously.

The at least one temperature sensor may be configured to record temperature data. According to one embodiment of the method, the at least one temperature sensor can make the recorded temperature data available for further use.

According to one embodiment of the method, the current mass Δm of the propellant absorbed by the polymer granulate is determined by means of the relationship:

$$Δ m = Δ {m}_{a} + \frac{V}{{R}_{S}} ( \frac{{p}_{1}}{{T}_{1}} - \frac{{p}_{2}}{{T}_{2}} ) .$$

In this case, p₁ and T₁ are an initial pressure prevailing in the inside before absorption of the propellant and an initial temperature prevailing in the inside before absorption of the propellant. p₂ and T₂ are the measured current pressure and the measured current temperature in the inside of the pressure vessel Δmₐ is the mass of the propellant subsequently introduced into the pressure vessel. V is the vessel volume not occupied by the polymer granulate. R_{S} is the specific gas constant of the gas or gas mixture; for the sake of simplicity, it can be assumed that it remains virtually constant during the course of the impregnation.

According to one embodiment of the method, the mass of the propellant initially introduced into the inside of the pressure vessel, the subsequently introduced mass Δmₐ, or the initially and subsequently introduced masses m₁, Δmₐ of the propellant is determined by means of a mass flow meter when the propellant is introduced into the inside of the pressure vessel.

A suitable mass flow meter is, for example, a Coriolis mass flow meter, but a different measuring principle can also be used.

By means of a mass flow meter, the mass of the propellant introduced initially and/or subsequently into the inside of the pressure vessel can be measured in a simple manner.

According to one embodiment of the method, the mass of the propellant initially introduced into the inside of the pressure vessel, the subsequently introduced mass Δmₐ or the initially and subsequently introduced masses m₁, Δmₐ of the propellant is determined by means of a balance, a load cell or a force transducer.

An initial total mass of the pressure vessel with the polymer granulate located in the inside can be determined. In particular, a total mass of the pressure vessel with the polymer granulate located in the inside and the propellant can be determined by means of a balance, a load cell or a force transducer. The total mass can be determined repeatedly, so that a current total mass can be measured.

The mass of the propellant initially introduced into the pressure vessel can be determined from the difference between the initial total mass and the total mass before the start of the impregnation.

The subsequently introduced mass of the propellant can be determined from a change in the total mass.

According to a further embodiment of the method, the gaseous propellant is one of the following gaseous substances or comprises at least one of the following substances: carbon dioxide (CO₂), nitrogen (N₂), argon (Ar), helium (He), or a hydrocarbon, butane, pentane, mixtures of one or more gases with CO₂.

A hydrocarbon may be, for example, butane or pentane.

According to the invention, the propellant can be a mixture of one or more gaseous substances with carbon dioxide.

According to one embodiment, the method is characterized in that the polymer granulate contains at least one of the following substances or is formed by one of the following substances: a thermoplastic, a thermosetting plastic, a thermoplastic particle foam, a granulate for producing a thermoplastic particle foam, polypropylene, expanded polypropylene (EPP), polystyrene, expanded polystyrene (EPS).

The polymer granulate can in particular comprise a hydrophilic material or consist of a hydrophilic material.

According to a further embodiment of the method, the pressure prevailing in the inside of the pressure vessel is lowered in order to terminate the impregnation of the polymer granulate.

According to one embodiment, the pressure in the pressure vessel is lowered when or after the predefined mass is reached in order to prevent further absorption of propellant in the polymer granulate. This is done, for example, by releasing the non-absorbed propellant into the environment via a relief valve, in which case the pressure is generally lowered to normal pressure, for example.

As a result, the polymer granulate releases continuously absorbed propellant again. With the relief valve still open, the amount of propellant escaped from the polymer granulate can be determined simply via the decrease in the total mass of the pressure vessel with polymer granulate and propellant contained therein.

Alternatively, the pressure can be lowered to a value higher than the ambient pressure and then the relief valve can be closed again. The mass of the propellant Δm₂ escaped from the polymer granulate can be determined using the formula

$$Δ {m}_{2} = \frac{V}{{R}_{S}} \cdot ( \frac{{p}_{4}}{{T}_{4}} - \frac{{p}_{3}}{{T}_{3}} ) .$$

In this case, T₃ is the temperature and p₃ is the pressure in the inside of the pressure vessel, and m₃ is the mass of the propellant contained in the gas volume of the pressure vessel, i.e. non-absorbed propellant, at the time when the relief valve is closed. T₄ and p₄ are a temperature and a pressure in the inside of the pressure vessel at a later time. In an advantageous embodiment, a pressure p₃ can be set at which no propellant escapes from the polymer granulate. This means that the impregnated polymer granulate can be stored as long as desired prior to further processing, while the degree of loading is maintained.

The degree of loading, i.e. the amount of propellant absorbed by the polymer granulate, can be determined during the impregnation using the method according to the invention.

Further features and advantages of the invention are explained below with reference to the description of the drawings of exemplary embodiments. The following are shown:

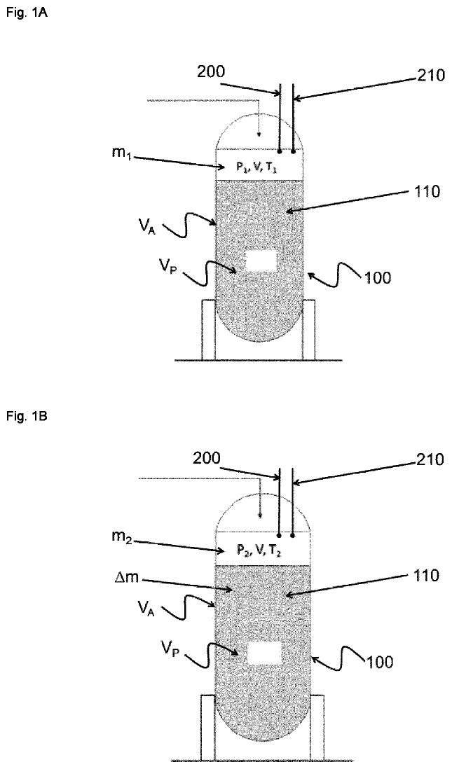

FIGS. 1A and 1B a diagram of the method, in which no additional propellant is added to the pressure vessel,

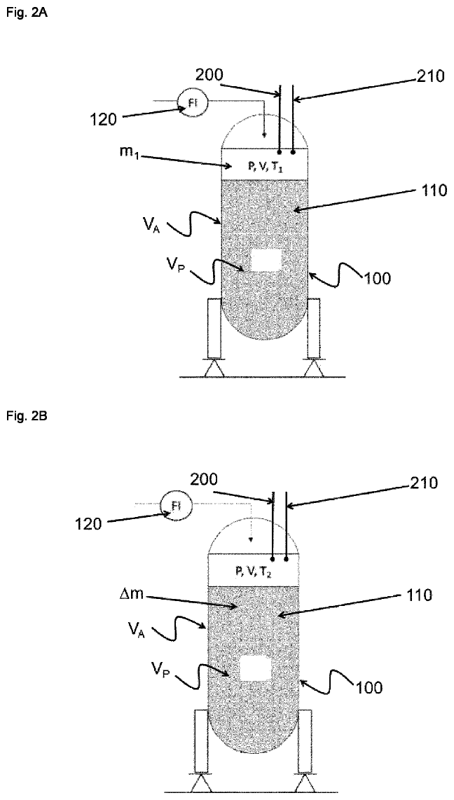

FIGS. 2A and 2B a diagram of the method, in which propellant is additionally added to the pressure vessel, the pressure is kept constant and corresponds to the initial pressure, and

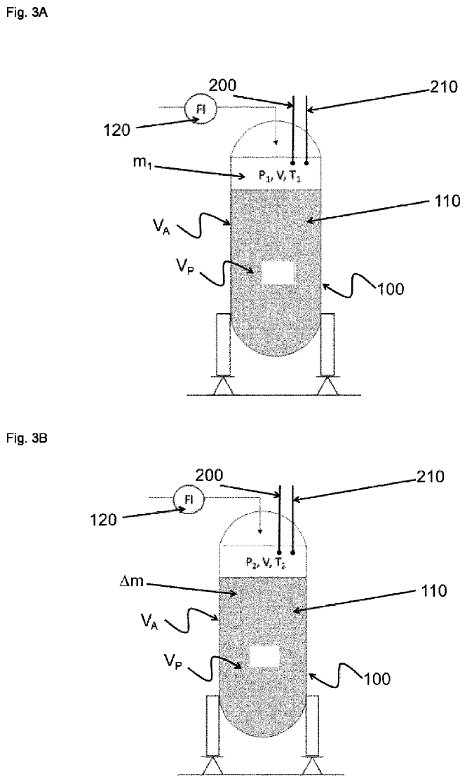

FIGS. 3A and 3B a diagram of the method, in which propellant is additionally added to the pressure vessel, but the pressure has a lower limit and differs from the initial pressure.

Using the method according to the invention, the end of the impregnation process can be determined by determining the mass of the propellant absorbed by the polymer granulate. A target of the impregnation can be specified, i.e. the degree of loading to be achieved, and the process of impregnation can be discontinued when this target is reached. For this purpose, it is determined in particular how much propellant has currently been absorbed by the polymer granulate by:

1. determining a current temperature in the pressure vessel, as well as a change in pressure in relation to an initial pressure, and/or
2. determining a mass of the propellant which is subsequently added to the pressure vessel.

FIGS. 1A and 1B illustrate an embodiment of the method according to the invention, in which an initial quantity of propellant gas m₁, for example CO₂, has been introduced into an inside of a pressure vessel 100, in which a polymer granulate 110 is arranged, and a current temperature T₂ in the pressure vessel 100 is determined, as well as a change in pressure in relation to an initial pressure p₁. FIG. 1A shows the state before the start of the impregnation (initial condition), and FIG. 1B shows the state during the impregnation.

For example, a degree of loading of 2% can be achieved with the aid of the method according to the invention. Th is means that the target is a degree of loading of 2%, and the process can be terminated when or after this target has been reached. A degree of loading of 2% means that the mass of the polymer granulate increases by 2% owing to absorption of the propellant. For example, if polymer granulate having a mass of 100 kg is arranged in the inside of the pressure vessel 100, a mass of 2 kg of the propellant must be absorbed by the polymer granulate 110 for a degree of loading of 2%.

With the proviso that the general gas equation

p·V=n·R·T

applies, where

$${R}_{S} = \frac{R}{M}$$

the following applies:

p·V=m·R_{S}·T

wherein
m is the mass of the gas, in particular of the propellant,
M is the molar mass of the gas, in particular of the propellant,
R is the universal gas constant, and
R_{S} is the specific gas constant.

At the start of the process of impregnation, the propellant, for example CO₂, obeys the equation:

p₁·V=m₁·R_{S}·T₁

In this case,

p₁ is the pressure in the inside of the pressure vessel 100 before the start of the absorption process, which pressure can also be referred to as initial pressure, T₁ is the temperature in the inside of the pressure vessel 100 before the start of the absorption process, which temperature can also be referred to as the initial temperature, V is the volume of the propellant in the inside of the pressure vessel 100, wherein the volume V of the propellant in the inside of the pressure vessel can be described as a difference between a volume of the inside of the pressure vessel V_{A} and a volume of the polymer granulate V_{P} arranged in the inside, and
R_{S} is the specific gas constant for which the following applies:

$${R}_{S} = \frac{R}{M} .$$

The initial pressure p₁ and the initial temperature T₁ can be measured, for example, by means of at least one pressure sensor 210 and a temperature sensor 200 in the inside of the pressure vessel 100. The volumes V_{A} and V_{P} can be determined so that the volume V of the propellant in the inside of the pressure vessel 100 can be determined. The specific gas constant of the propellant is known or can be calculated.

This can be used to calculate the mass m₁ by means of the relationship:

$${m}_{1} = \frac{{p}_{1 \cdot } V}{{R}_{S} \cdot {T}_{1}} .$$

In an alternative embodiment, the mass m₁ can be measured by means of a mass flow meter on introduction into the pressure vessel 100.

During the impregnation, a current temperature T₂ and a current pressure p₂ in the inside of the pressure vessel 100 are determined. In one embodiment, the current pressure p₂ and the current temperature T₂ are determined continuously. The current pressure p₂ can be measured, for example, by means of at least one pressure sensor 210 in the inside of the pressure vessel 100. The current temperature T₂ can be measured by means of at least one temperature sensor 200 in the inside of the pressure vessel 100.

During impregnation, at least a portion of the propellant is absorbed by the polymer granulate 110. The current pressure p₂ falls in comparison with the initial pressure p₁. The current temperature T₂ may differ from the initial temperature T₁. The volume of the propellant in the inside of the pressure vessel V remains unchanged in comparison with the volume V of the propellant in the inside of the pressure vessel 100 before the start of the absorption.

After a certain period of time, in which at least a portion of the propellant has been bound by the polymer granulate 110, the following applies:

p₂·V=m₂·R_{S}·T₂.

In this case, the mass m₂ describes the mass of the propellant in the inside of the pressure vessel 100 at the current temperature T₂ and the current pressure p₂ which has not been absorbed by the polymer granulate 110 and can be calculated to give

$${m}_{2} = \frac{{p}_{2} \cdot V}{{T}_{2} \cdot {R}_{S}} .$$

A current mass of the propellant that has been absorbed by the polymer granulate 110, Δm, can easily be calculated using the relationship

Δm=m₁−m₂.

In one embodiment of the method according to the invention, the current mass of the propellant that has been absorbed by the polymer granulate, Δm, can be determined, in particular dynamically determined, by means of a programmable logic controller. In particular, the programmable logic controller can calculate the current mass Δm from pressure measurements and temperature measurements of the initial variables and the current variables (p₁, p₂, T₁, T₂) that can be provided by the at least one pressure sensor 210 and the at least one temperature sensor 200.

If the determined value of the current mass Δm corresponds to the target, the process of impregnation may be terminated.

In the case where the target is a degree of loading of 2% for 100 kg of polymer granulate 100, the impregnation can be terminated when Δm=2 kg is reached.

FIGS. 2A and 2B illustrate a variant of the method according to the invention, in which an initial quantity of propellant gas m₁, for example CO₂, is introduced into a pressure vessel 100, in which a polymer granulate 110 is arranged, and additional propellant Δmₐ is continuously added to the pressure vessel 100, so that the pressure in the inside of the pressure vessel remains constant, i.e., that the current pressure p₂ is equal to the initial pressure p₁. FIG. 2A shows the state before the start of the impregnation (initial condition) and FIG. 2B shows the state during the impregnation.

As in the method described in FIGS. 1A and 1B, a propellant is introduced into the inside of a pressure vessel 100, and the mass of the initial propellant m₁, the initial temperature T₁, the initial pressure p₁ and the volume V of the propellant gas in the inside of the pressure vessel 100 are determined.

During the impregnation, the current temperature T₂ and the current pressure p₂ can be measured by means of at least one suitable sensor 200, 210 in the inside of the pressure vessel 100.

During the impregnation, additional propellant having a mass Δmₐ can be added to the inside of the pressure vessel 100.

In one embodiment of the method, propellant can be added to the inside of the pressure vessel 100 at regular intervals when a difference between the initial pressure p₁ and the current pressure p₂ has an absolute value of more than 0.5 bar. In an alternative embodiment, additional propellant can be added if the one difference between the initial pressure p₁ and the current pressure p₂ has an absolute value of more than 0.3 bar, in particular more than 0.1 bar.

In an alternative embodiment, additional propellant can be added to the inside of the pressure vessel 100 continuously, in particular using a pressure regulator.

The addition of the additional propellant can be monitored in particular by means of a programmable logic controller.

According to one embodiment of the method, the mass Δmₐ of the additionally added propellant can be measured by means of a mass flow meter 120. In this case, the mass Δmₐ of the additionally added propellant can be composed of a plurality of partial masses, wherein a partial mass of the plurality of partial masses can be introduced into the inside of the pressure vessel 100 at a specific time t. A programmable logic controller can be used to determine the mass Δmₐ of the additionally added propellant, in particular from the sum of the plurality of partial masses. When the mass Δmₐ of the additionally added propellant has reached the target, the process of impregnation can be terminated. In an embodiment of the method according to the invention, the process of impregnation can be terminated automatically when the target is reached.

In an alternative embodiment, the mass Δmₐ of the additionally added propellant can be determined by determining a total mass. The total mass can be determined using a mass of the pressure vessel, a mass of the polymer granulate arranged in the pressure vessel, and a mass of the propellant gas present in the pressure vessel. The total mass can be determined by means of a balance or a load cell, for example. The total mass can be determined before the start of the impregnation; said mass is also referred to as the initial total mass. Furthermore, a current total mass can be determined, and a difference between the current total mass and the initial total mass can be determined, in particular calculated.

The mass of the propellant Δm absorbed by the polymer granulate can be determined according to the relationship: Δm=Δmₐ−Δm_{b} wherein Δmₐ is the mass of the additionally added propellant and Δm_{b} describes a change in the mass of the non-absorbed propellant present in the inside of the pressure vessel 100 as a function of the initial temperature T₁ and the current temperature T₂. In other words, Δm_{b} describes the effect of the temperature on the non-bonded propellant in the inside of the pressure vessel 100.

From the ideal gas equation, it can be seen that the change in the mass of the non-absorbed propellant in the inside of the pressure vessel Δm_{b} at a constant pressure (i.e. p₁=p₂) behaves according to the following relationship:

$$Δ {m}_{b} = \frac{{p}_{1} \cdot V}{{R}_{S}} \cdot ( \frac{1}{{T}_{2}} - \frac{1}{{T}_{1}} )$$

wherein m₁ is the mass of the propellant initially introduced into the inside of the pressure vessel, and wherein T₁ and T₂ are the initial temperature and the current temperature. More accurate results can be achieved by a calculation with the aid of real gas factors, but this is less practice-oriented.

In a case, in which the current temperature T₂ falls in comparison with the initial temperature T₁, i.e. T₁>T₂, during the process of impregnation, Δm_{b} assumes a positive value. Less propellant has thus been absorbed by the polymer granulate than would be indicated by an increase in the total mass.

In an alternative embodiment of the method (FIGS. 3A and 3B), polymer granulate and an initial mass m₁ of a propellant are positioned or introduced in the inside of a pressure vessel 100 as in the methods described above. The initial mass m₁ and initial pressure p₁ and initial temperature T₁ can be determined.

The total mass, the current temperature T₂ and the current pressure p₂ can be determined during the process of impregnation. Additional propellant Δmₐ may be introduced into the inside of the pressure vessel 100, wherein such a mass Δmₐ of the additional propellant is introduced that the current pressure p₂ is different from the initial pressure p₁ after the additional introduction. This means that the pressure can drop by a predefined value without being counteracted by adding the propellant. If the current pressure p₂ decreases further, in particular below a predefined threshold value, additional propellant can be introduced. A fall in the efficiency of the impregnation can thus be counteracted. For example, if the current pressure p₂ is too low, the impregnation may take longer than at a higher current pressure p₂.

The advantage of this method could be that the mass of the non-absorbed propellant m₂ lost after impregnation could be reduced in comparison with the method in which additional propellant is supplied so that the current pressure p₂ is equal to the initial pressure p₁.

1. A method for impregnating a polymer granulate (110) with a predefined mass of a gaseous propellant, wherein
the polymer granulate (110) is arranged in an inside of a pressure vessel (100),
a gaseous propellant is initially introduced into the inside of the pressure vessel (100), propellant being absorbed by the polymer granulate (110), and a current pressure (p₂) prevailing in the inside being measured,
wherein a current mass (Δm) of the propellant absorbed by the polymer granulate is determined as the difference between the mass (m₁) of the total propellant initially introduced into the inside of the pressure vessel and the mass (m₂) of a non-absorbed part of the propellant currently located in the inside, and wherein the method is discontinued when the current mass (Δm) of the absorbed propellant is greater than or equal to the predefined mass.

2. The method according to claim 1, wherein a current temperature (T₂) in the inside of the pressure vessel (100) is measured.

3. The method according to claim 1, wherein the current mass (Δm) is determined by means of a programmable logic controller.

4. The method according to claim 1, wherein the mass of the non-absorbed part of the propellant (m₂) currently located in the inside is determined by means of the relationship:
$${m}_{2} = \frac{{p}_{2} \cdot V}{{R}_{S} \cdot {T}_{2}}$$
wherein
p₂ and T₂ are the current pressure and the current temperature in the inside of the pressure vessel, R_{S} is the specific gas constant of the gas or gas mixture present in the pressure vessel, and V is the vessel volume not occupied by the polymer granulate.

5. A method for impregnating a polymer granulate with a predefined mass of a gaseous propellant, wherein
the polymer granulate (110) is arranged in an inside of a pressure vessel (100),
a gaseous propellant is initially introduced into the inside of the pressure vessel (100) so that propellant is absorbed by the polymer granulate (110), and wherein propellant is subsequently added to the inside of the pressure vessel (100), wherein the masses of the initially (m₁) and subsequently introduced propellant (Δmₐ) are determined,
a current mass (Δm) of the propellant absorbed by the polymer granulate is determined using the masses of the propellant initially (m₁) and subsequently (Δmₐ) introduced into the inner space, and wherein the method is discontinued when the current mass (Δm) of the absorbed propellant is greater than or equal to the predefined mass.

6. The method according to claim 5, wherein a current temperature (T₂) is measured in the inside of the pressure vessel (100).

7. The method according to claim 5, wherein the current pressure (p₂) prevailing in the inside of the pressure vessel (100) is measured and the respectively subsequently introduced propellant is introduced into the inside of the pressure vessel (100) continuously, so that the pressure prevailing in the inside of the pressure vessel (100) remains constant.

8. The method according to claim 5, wherein the current mass (Δm) of the propellant absorbed by the polymer granulate (110) is determined by means of the relationship
$$Δ {m}_{b} = Δ {m}_{a} - \frac{{p}_{1} \cdot V}{{R}_{S}} \cdot ( \frac{1}{{T}_{2}} - \frac{1}{{T}_{1}} )$$
wherein m₁ and Δmₐ are the masses of the propellant initially and subsequently introduced into the inside of the pressure vessel (100), wherein
T₁ is an initial temperature prevailing in the inside of the pressure vessel (100) before the absorption of the propellant, and wherein T₂ is the current temperature in the inside of the pressure vessel, V is the volume of the pressure vessel not occupied by the polymer granulate, R_{S} is the specific gas constant of the gas in the vessel, and p₁ is the constant pressure in the pressure vessel.

9. The method according to claim 5, wherein the current pressure (p₂) prevailing in the inside of the pressure vessel (100) is measured, and wherein the current mass (Δm) of the propellant absorbed by the polymer granulate is determined using the masses of the propellant initially (m₁) and subsequently (Δmₐ) introduced into the inside and the current pressure (p₂), and wherein the method is discontinued when the current mass (Δm) of the absorbed propellant is greater than or equal to the predefined mass.

10. The method according to claim 9, wherein the current mass (Δm) of the propellant absorbed by the polymer granulate (110) is determined by means of the relationship
$$Δ {m}_{b} = Δ {m}_{a} - \frac{V}{{R}_{S}} \cdot ( \frac{{p}_{2}}{{T}_{2}} - \frac{{p}_{1}}{{T}_{1}} )$$
wherein m₁ and Δmₐ are the masses of the propellant initially and subsequently introduced into the inside of the pressure vessel (100), p₁ and T₁ are an initial pressure prevailing in the inside before absorption of the propellant and an initial temperature prevailing in the inside of the pressure vessel (100) before absorption of the propellant, and wherein p₂ and T₂ are the current pressure and the current temperature in the inside of the pressure vessel (100), V is the volume of the pressure vessel not occupied by the polymer granulate, R_{S} is the specific gas constant of the gas in the vessel.

11. The method according to claim 1, wherein
the mass (m₁) of the propellant initially introduced into the inside of the pressure vessel, or
the mass (Δmₐ) of the propellant subsequently introduced into the inside of the pressure vessel (100), or
the masses (m₁, Δmₐ) of the propellant initially and subsequently introduced into the inside of the pressure vessel (100)
are determined when the propellant is introduced into the inside of the pressure vessel (100) by means of a mass flow meter (120).

12. The method according to claim 1, wherein
the mass (m₁) of the propellant initially introduced into the inside of the pressure vessel, or
the mass (Δmₐ) of the propellant subsequently introduced into the inside of the pressure vessel (100), or
the masses (m₁, Δmₐ) of the propellant initially and subsequently introduced into the inside of the pressure vessel (100), or
the mass of the polymer granulate arranged in the pressure vessel (100)
are determined by means of a balance, a load cell or a force transducer.

13. The method according to claim 1, wherein the gaseous propellant is one of the following gaseous substances or comprises at least one of the following substances: carbon dioxide (CO₂), nitrogen (N₂), argon (Ar), helium (He), a hydrocarbon, butane, pentane, mixtures of one or more gases with CO₂.

14. The method according to claim 1, wherein the polymer granulate (110) contains at least one of the following substances or is formed by one of the following substances: a thermoplastic, a thermosetting plastic, a thermoplastic particle foam, a granulate for producing a thermoplastic particle foam, polypropylene, expanded polypropylene (EPP), polystyrene, expanded polystyrene (EPS).

15. The method according to claim 1, wherein order to terminate the impregnation of the polymer granulate with the propellant, the pressure prevailing in the inside of the pressure vessel (100) is reduced to:
an ambient pressure, wherein in particular the amount of propellant released again from the polymer granulate on account of the pressure reduction is determined gravimetrically, or
a pressure which is higher than an ambient pressure and at which, in particular, the polymer granulate neither absorbs nor loses any further propellant.
